(19) United States
(12) Patent Application Publication
(10) Pub. No.: US 2007/0081184 A1
(43) Pub. Date: Apr. 12, 2007

(54) System and method for releasing multiple document processing operations

(76) Inventors: Brenda F. Daos, Mission Viejo, CA (US); Vincent Wu, Irvine, CA (US); Jianxin Wang, Trabuco Canyon, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/248,041

(22) Filed: Oct. 12, 2005

(51) Int. Cl. G06F 3/12

(52) U.S. Cl. 358/1.15

(57) ABSTRACT

This invention is directed to a system and method for releasing multiple document processing operations. A document processing device first receives data representing a plurality of pending document processing operations. Identification data is then input by an associated user representing the identification of the user associated with the pending document processing operations. The pending document processing operations are then displayed to the associated user via an associated user interface by the document processing device. The user then selects one or more document processing operations, upon which a document processing operation is subsequently commenced by the document processing device.

### BACKGROUND OF THE INVENTION

This invention is directed to a system and method for releasing multiple document processing operations. More particularly, this invention is directed to a system and method for restricting view access to confidential document processing operations and releasing multiple document processing operations related thereto.

Office computer networks generally include one or more document processing devices, such as multifunctional peripheral devices. These multifunctional devices are generally capable of performing a variety of document processing operations, such as printing, scanning, or copying. Each of the devices residing on the computer network may be equipped with different features or capabilities, allowing one device to output color documents while the remaining devices are limited to monochromatic output. Generally, users select the device capable of performing a desired operation and then send a corresponding document processing request to the selected device. When the user desires to maintain a confidential or proprietary nature of document processing request, various security measures are implemented to facilitate the secure handling of electronic document data. However, once a user has enabled the security resources of a specified device, the user is required to input in some manner a password or other identification means to continue the processing of the submitted electronic document. The user generally selects the submitted document from a list of confidential document processing operations pending in a secure document processing queue at the selected multifunctional device. Thus, each document processing request of a confidential nature is viewable by a user not necessarily associated with that request.

Furthermore, security measures generally require a user to input a password or other authenticating information directly into the multifunctional peripheral device. Each operation on the device associated with the user must be individually selected by the user. Before the selected document processing operation may be completed by the multifunctional peripheral device, the user is required to input the password or other authentication data. Thus, a user is required to input a password for each document processing operation to which the user is associated, even when multiple operations are pending on the same document processing device.

Therefore, there is a need for a system and method for restricting viewing access to confidential document processing operations and for releasing multiple document processing operations associated therewith.

### SUMMARY OF THE INVENTION

In accordance with the present invention, there is provided a system and method for releasing multiple document processing operations.

Further in accordance with the present invention, there is provided a system and method for the restricting view access to confidential document processing operations and releasing multiple document processing operations related thereto.

Still further, in accordance with the present invention, there is provided a system and method for selectively releasing and deleting multiple document processing operations in response to the selection of the document processing operations by an authenticated user.

In accordance with the present invention, there is provided a system for releasing multiple document processing operations. The system includes receiving means adapted to receive data representing a plurality of pending document processing operations. The system also includes receiving means adapted to receive identification data representing the identification of a user associated with the pending document processing operations. In addition, the system includes display means adapted to generate a display containing data representing the document processing operations. The system further includes receiving means adapted to receive a selection signal of the selection of at least one document processing operation on the display and group release means adapted to commence a document processing operation on the at least one document processing operation associated with the selection signal.

Still further, in accordance with the present invention, there is provided a method for releasing multiple document processing operations. The method begins with the receipt of data representing a plurality of pending document processing operations. Next, identification data is received representing the identification of a user associated with the pending document processing operations. A display is then generated including data representing the pending document processing operations. A selection signal is then received representing the selection of at least one document processing operation on the display, and a document processing operation on the at least one document processing operation associated with the selection signal is subsequently commenced.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain parts, and arrangements to parts, which are evidenced in conjunction with the associated drawings, which form a part hereof and not, for the purposes of limiting the same in which:

FIG. 1 is a block diagram of the system according to the present invention;

FIG. 2 is a flowchart illustrating the client side of the method according to the present invention; and

FIG. 3 is a flowchart illustrating the document processing device side of the method according to the present invention.

### DETAILED DESCRIPTION OF THE PREFERRED EMBODIMENT

This invention is directed to a system and method for releasing multiple document processing operations. In particular, this invention is directed to a system and method for the restricting view access to confidential document processing operations and releasing multiple document processing operations related thereto. More particularly, the present invention is directed to a system and method for selectively releasing and deleting multiple document processing operations in response to the selection of the document processing operations by an authenticated user at an associated document processing device. Preferably, the document processing device is a multifunctional peripheral device, capable of providing scanning, copying, facsimile, printing, document management, document storage, electronic mail, and other functions to a user.

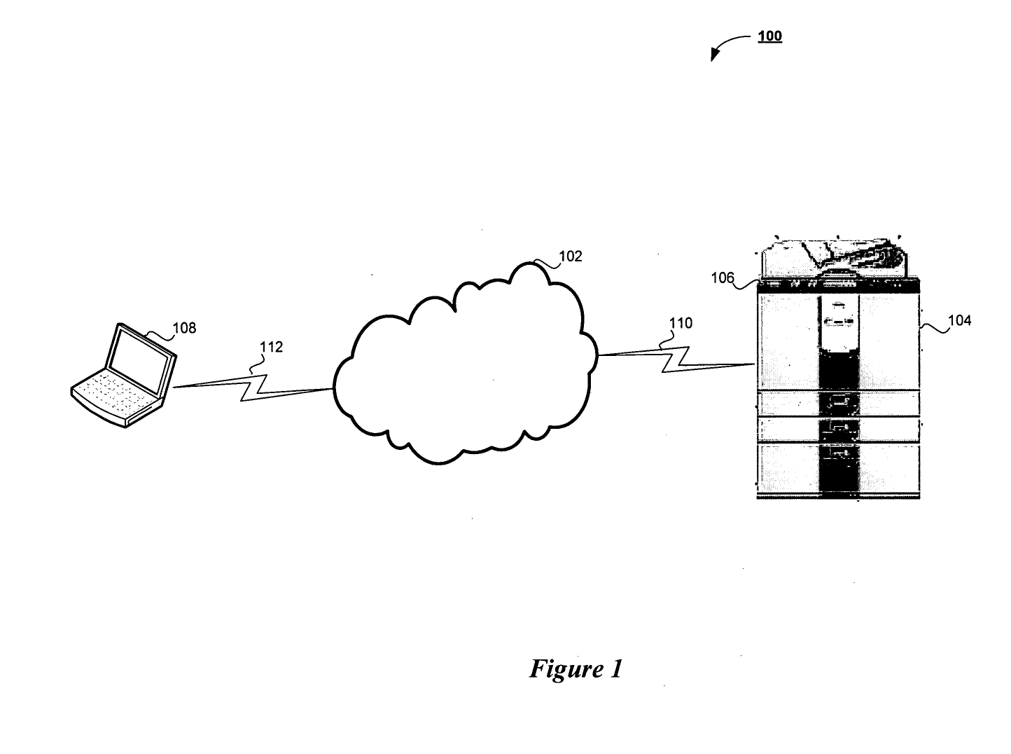

Turning now to FIG. 1, there is shown a system 100 in accordance with the present invention. As shown in FIG. 1, the system 100 suitably includes a computer network 102. It will be appreciated by those skilled in the art that the computer network 102 is any computer network, known in the art, which is capable of enabling the communication of data between two or more electronic devices. As the skilled artisan will appreciate, the present invention is capable of incorporation on any such computer network including, for example and without limitation, Ethernet, local area network, wide area network, personal area network, Token Ring, the Internet, intranets, and the like. In the preferred embodiment, the present invention is employed over a corporate network, such as a local area network. The skilled artisan will appreciate that the present invention is equally capable of being employed on a wide area network, a wireless local area network, the Internet, and the like. In one embodiment, the computer network 102 is suitably equipped with administratively-enabled security protocols, such as unique user identification/password combinations, to control access to the computer network 102 and any associated electronic devices connected thereto.

The system 100 further includes a document processing device 104, communicatively coupled to the network 102 via a suitably communications link 110. It will be appreciated by those skilled in the art the document processing device 104 is advantageously represented in FIG. 1 as a multifunction peripheral device, suitably adapted to provide a variety of document processing services, such as, for example and without limitation, scanning, copying, facsimile, printing, and the like. Suitable commercially available image generating devices include, but are not limited to, the Toshiba e-Studio Series Controller. In one embodiment, the document processing device 104 is suitably equipped to receive a plurality of portable storage media, including without limitation, Firewire, USB, SD, MMC, XD, Compact Flash, Memory Stick, and the like. The communications link 110 is any suitable channel of data communications known in the art including, but not limited to wireless communications, for example and without limitation, Bluetooth, WiMax, 802.11a, 802.11b, 802.11g, 802.11(x), infrared, optical, or any suitable wireless data transmission system, or wired communications known in the art. In the preferred embodiment of the present invention, the document processing device 104 further includes a user-interface 106. More preferably, the user-interface 106 is a touch-screen user-interface, however any other suitable means of user interaction, such as an alphanumeric keypad, mouse, LCD, or any combination thereof, are equally capable of being employed to receive instructions from the user.

The system 100 also includes at least one client device, illustrated in FIG. 1 as a laptop computer 108. It will be appreciated by those skilled in the art that the present invention is not limited to a single client device, but rather is capable of allowing any number of client devices, to be used in accordance with the present invention. The client device 108 is suitably equipped to communicate with the computer network 102 via the communications link 112. As will be understood by those skilled in the art, the communications link 112 is representative of a plurality of communications channels which the client device 108 is capable of using to exchange data with the network 102. Thus, for example and without limitation, the communications link 112 is any wired or wireless data communications channel known in the art, such as Bluetooth, WiMax, 802.11a, 802.11b, 802.11g, 802.11(x), infrared, optical, and the like. It will further be appreciated by those skilled in the art that the client device 108 is capable of being any personal electronic device known in the art capable of interacting with the computer network 102 and the document processing device 104. For example and without limitation, suitable client devices include a smart phone, a personal data assistant, a desktop computer, a web-enabled cellular communications device, and the like.

In operation, a user, associated with the client device 108, selects one or more documents for processing on a networked document processing device 104. In accordance with one aspect of the present invention, the user elects to execute a confidential, or secure, document processing operation so as to prevent other network users from viewing the document during transmission and/or output by the document processing device 108. The selected document in the form of electronic document data is then composed into a secure document processing request and transmitted from the client device 108 to the document processing device 104 via the computer network 102. The skilled artisan will appreciate that the electronic document data is suitably capable of being transmitted as a direct print submission from a printer driver associated with the client device 108, as an attachment to an electronic mail message, and the like.

When the document processing device 104 receives the secure document processing request, the electronic document is shunted into a print queue corresponding to secure document processing operations. The document data resides in the secure queue until the user elects to continue the document processing operation. To continue with the processing of the electronic document data, the user inputs at the document processing device 104, a user identification and/or password combination. The input combination is then used to authenticate the user. Preferably, the identification information is submitted via the associated user-interface 106. In the preferred embodiment, the document processing device 104 uses the document processing request submitter's network authenticated information, i.e., username/password, to restrict access to the secure document processing queue. The document processing device 104 verifies the identification information and determines whether or not the user is an administrator or other user with greater rights than a normal user. When the user is a normal user, the document processing device 104 retrieves all document processing requests corresponding solely to that user and displays them to the user via the associated user-interface 106. The user then selects one or more of the displayed document processing requests for further processing by the document processing device 104. Alternatively, the user is able to delete the selected document processing requests, thereby removing the electronic documents from the queue on the document processing device 104.

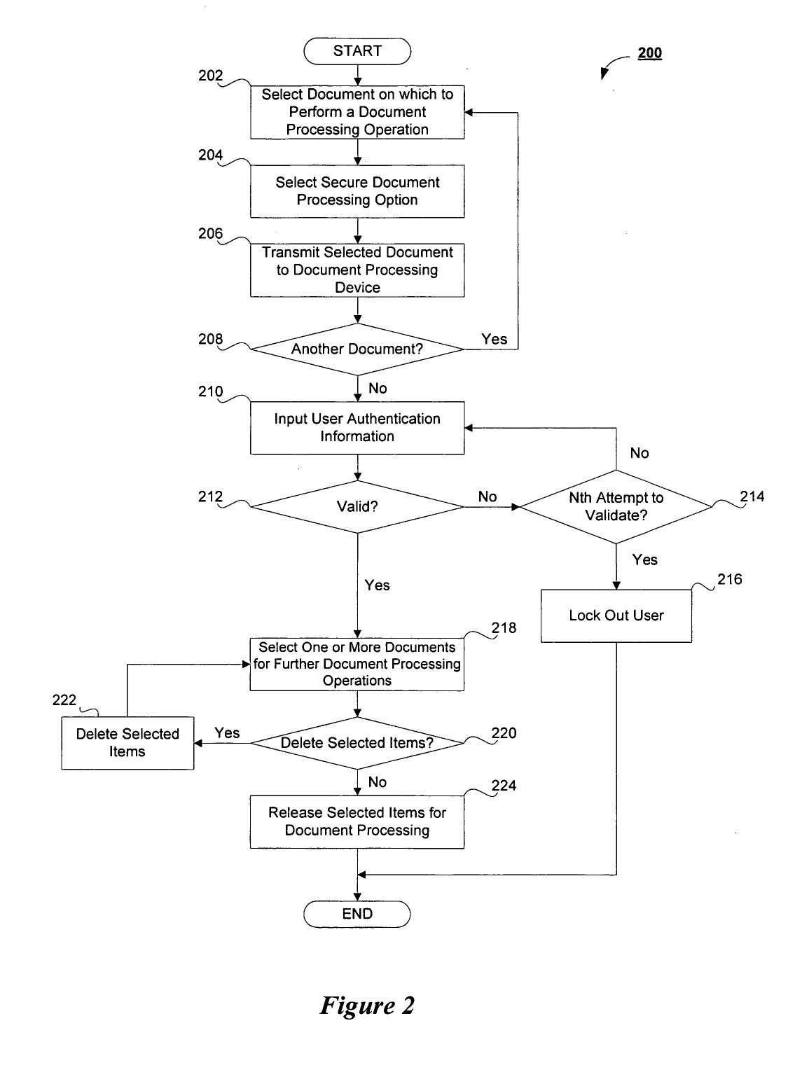

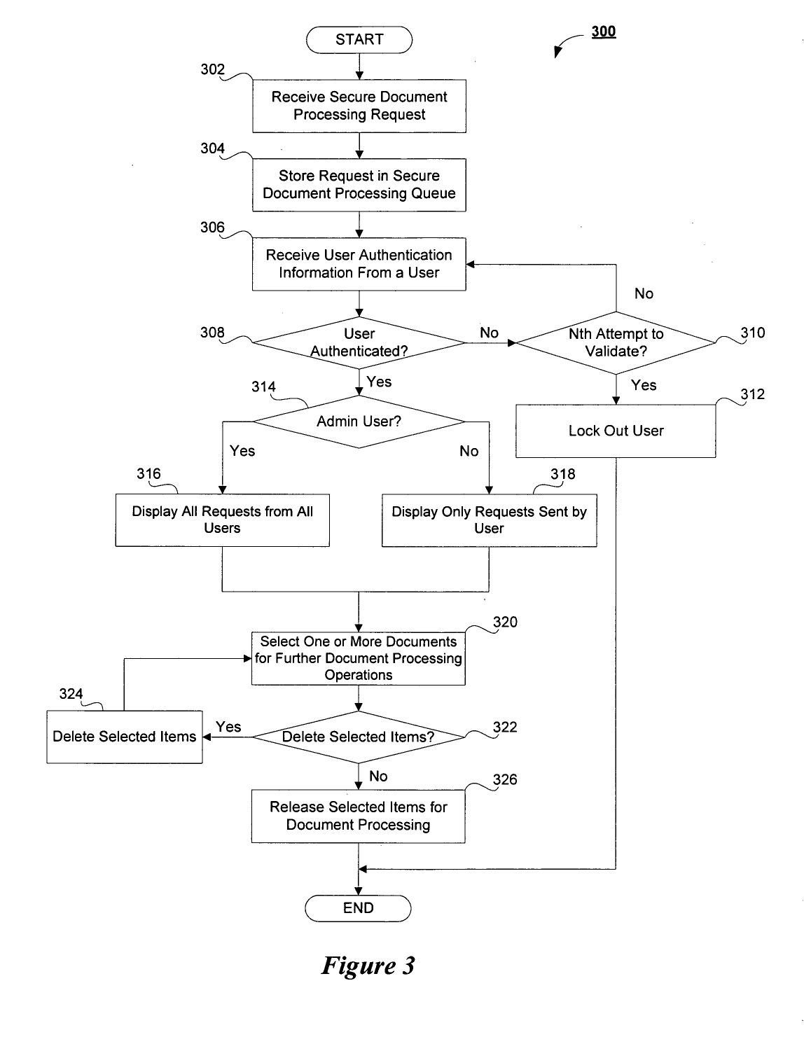

When the user has been verified as being an administrator or a user with greater access rights, the document processing device 104 displays all pending secure document processing requests, irrespective of the originator of the request. The user is then prompted, via the associated user-interface 106, to select one or more of the displayed requests for further processing by the document processing device 104, or alternatively to delete the selected requests and remove the corresponding electronic documents from the document processing device 104. The operation of the system 100 of the present invention will better be understood in conjunction with the flowcharts, described in FIGS. 2 and 3, below.

Referring now to FIG. 2, there is shown a flowchart 200 illustrative of a user-side method for releasing multiple document processing operations. In accordance with the present invention, the method begins with the selection of a document on which to perform a document processing operation at step 202. It will be understood by those skilled in the art that the user, suitably selects the electronic document for processing by the document processing device 104 via the client device 108. At step 204, the user selects the secure document processing option, whereupon the electronic document data is submitted to the document processing device at step 206. It will further be understood by those skilled in the art that the secure document processing option informs the document processing device 104 to await further user input prior to performing the selected document processing operation. A determination is then made at step 208 whether the user desires to submit any additional documents for processing. A positive determination returns the flow to step 202, requiring the user to select the additional documents.

Upon a negative determination at step 208, the user approaches the document processing device 104 to which the secure document processing request was submitted. At step 210 the user inputs, via the associated user-interface 106, authentication information. Preferably, the authentication information is in the form of a username/password corresponding to the network login identification of the user. A determination is then made at step 212 whether the authentication information is valid. A negative result prompts a determination at step 214 whether the attempt to authenticate has exceeded a predetermined number of attempts. When the attempt has not exceeded the predetermined number of attempts, flow returns to step 210, wherein the user submits authentication information. When the user has exceeded the predetermined number of allowable authentication attempts, flow proceeds to step 216, whereupon the user associated with the invalid attempts is locked out of the system and operation terminates.

When the user authentication information is determined to be valid at step 212, flow proceeds to step 218, whereupon the user selects one or more documents for further document processing operations. It will be understood by those skilled in the art that selection of the documents is accomplished via the associated user-interface 106. It will further be appreciated by those skilled in the art that the documents from which the user selects will be determined based upon the user's access rights and privileges, as determined by the document processing side of the present invention, illustrated in FIG. 3 and discussed in detail below. Once the user has selected the desired documents and the corresponding operations, flow proceeds to step 220, wherein a determination is made whether the user has selected a delete operation in connection with the selected documents. For example, when the user desires to avoid outputting the documents, realizes a mistake has been made, or that he no longer needs the documents, the user is able, via the user-interface 106, to select a delete operation, whereupon the selected documents are deleted. Thus a positive determination at step 220 prompts the deletion of the selected document processing requests at step 222, thereupon flow returns to step 218. It will be appreciated by those skilled in the art that when the deletion of all documents corresponding to the user has been accomplished, and when the user is not authorized to view any other documents pending on the document processing device 104, operation in accordance with the present invention terminates. When the user has not selected at step 220 to delete the selected documents, flow proceeds to step 224, wherein the document processing device 104 suitably performs the operations associated with the submitted document processing requests and operations in accordance with the present invention terminate.

Turning now to FIG. 3, there is shown a flowchart 300 illustrating a document processing device side method for releasing multiple document processing operations. In accordance with the present invention, the method begins at step 302, wherein the document processing device 104 receives a secure document processing request inclusive of an electronic document. The received document processing request is then locally stored, at step 304, in a secure document processing queue associated with the document processing device. At step 306, the document processing device 104 receives, via the associated user-interface 106, authentication information from a user seeking access to the document processing device 104. A determination is then made at step 308 whether the authentication information is valid, i.e., whether the information input by the user corresponds to a valid username/password network authentication. When the input authentication information is invalid, flow proceeds to step 310, wherein a determination is made whether the authentication attempt exceeds a predetermined number of validation attempts. Thus, the document processing device 104 determines at step 310 whether or not the user has made several attempts to login to the device 104. When the current attempt does not exceed the allowed number of attempts, flow returns to step 306, whereupon the user inputs the correct authentication information. When the current attempt exceeds the maximum number of allowed attempts, flow proceeds to step 312, wherein the user is locked out of the device 104 and the operation terminates.

Returning to step 308, when the authentication information input by the user has been verified, flow proceeds to step 314, wherein the document processing device 104 determines whether the user is a normal user or an administrative user, i.e., whether or not the user has administrative rights with respect to the document processing device 104. When the user is an administrative user, flow proceeds to step 316, where all pending secure document processing requests are displayed to the user on the associated user-interface 106. When the user is a normal user, flow proceeds to step 318, where only those pending secure document processing requests submitted by the user are displayed by the associated user-interface 106. In either event, flow progresses to step 320, wherein the user selects one or more of the displayed requests for further document processing by the document processing device 104.

At step 322, a determination is made whether the user has elected to delete the selected pending document processing requests. When such a determination is positive, flow proceeds to step 324, whereupon the selected requests are deleted from the pending queue and the documents are removed from the document processing device 104. Flow then returns to step 320, wherein the user is able to select one or more additional documents for further document processing operations. It will be understood by those skilled in the art that in the event that the user has selected all displayed document processing requests for deletion, the selected documents are deleted and the operation terminates, as no more requests are capable of being displayed. When the user has not selected to delete the selected requests, flow proceeds to step 326, wherein the one or more selected document processing requests are released for document processing by the document processing device 104.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

While in the preferred embodiment the present invention is implemented in software, as those skilled in the art can readily appreciate it may also be implemented in hardware or a combination of software and hardware. Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A system for releasing multiple document processing operations comprising:
means adapted for receiving data representative of a plurality of pending document processing operations;
means adapted for receiving identification data representative of an identification of a user associated with the plurality of pending document processing operations;
display means adapted for generating a display inclusive of data representative of the plurality of document processing operations;
means adapted for receiving a selection signal representative of a selection of at least one document processing operation on the display; and
group release means adapted for commencing a document processing operation on the at least one document processing operation associated with the selection signal.

2. The system for releasing multiple document processing operations of claim 1 further comprising:
password means adapted for receiving password input data; and
means adapted for enabling the group release means after receipt of valid password input data.

3. The system for releasing multiple document processing operations of claim 2 further comprising means adapted for receiving a selection signal representative of a selection of all document processing operations associated with the user.

4. The system for releasing multiple document processing operations of claim 3, wherein the display means generates the display inclusive of data representative of a plurality of document processing operations upon receipt of valid password input data.

5. The system for releasing multiple document processing operations of claim 4 further comprising:
selection means adapted for selecting at least one of the plurality of document processing operations; and
deletion means adapted for deleting the at least one selected document processing operation.

6. The system for releasing multiple document processing operations of claim 3 further comprising means adapted for receiving administrator login data, inclusive of data representative of an identification of a pre-designated system administrator, and wherein the display means is adapted, upon receipt of acceptable administrator login data, to display data representative of a plurality of document processing operations associated with a plurality of users.

7. The method for releasing multiple document processing operations of claim 6, further comprising:
selection means adapted for selecting at least one of the plurality of document processing operations; and
deletion means adapted for deleting the at least one selected document processing operation.

8. A method for releasing multiple document processing operations comprising the steps of:
receiving data representative of a plurality of pending document processing operations;
receiving identification data representative of an identification of a user associated with the plurality of pending document processing operations;
generating a display inclusive of data representative of the plurality of document processing operations;
receiving a selection signal representative of a selection of at least one document processing operation on the display; and
commencing a document processing operation on the at least one document processing operation associated with the selection signal.

9. The method for releasing multiple document processing operations of claim 8 further comprising the steps of:
receiving password input data; and
enabling the commencement of the document processing operation after receipt of valid password input data.

10. The method for releasing multiple document processing operations of claim 9 further comprising the step of receiving a selection signal representative of a selection of all document processing operations associated with the user.

11. The method for releasing multiple document processing operations of claim 10, wherein the display is generated inclusive of data representative of a plurality of document processing operations upon receipt of valid password input data.

12. The method for releasing multiple document processing operations of claim 11 further comprising the steps of:
selecting at least one of the plurality of document processing operations; and
deleting the at least one selected document processing operation.

13. The method for releasing multiple document processing operations of claim 10 further comprising the steps of:
receiving administrator login data, inclusive of data representative of an identification of a pre-designated system administrator; and
displaying, upon receipt of acceptable administrator login data, data representative of a plurality of document processing operations associated with a plurality of users.

14. The method for releasing multiple document processing operations of claim 13, further comprising the steps of:
selecting at least one of the plurality of document processing operations; and
deleting the at least one selected document processing operation.

15. A computer-readable medium of instructions with computer-readable instructions stored thereon for releasing multiple document processing operations comprising:
instructions for receiving data representative of a plurality of pending document processing operations;
instructions for receiving identification data representative of an identification of a user associated with the plurality of pending document processing operations;
instructions for generating a display inclusive of data representative of the plurality of document processing operations;
instructions for receiving a selection signal representative of a selection of at least one document processing operation on the display; and
instructions for commencing a document processing operation on the at least one document processing operation associated with the selection signal.

16. The computer-readable medium of instructions with computer-readable instructions stored thereon for releasing multiple document processing operations of claim 15 further comprising:
instructions for receiving password input data; and
instructions for enabling the commencement of the document processing operation after receipt of valid password input data.

17. The computer-readable medium of instructions with computer-readable instructions stored thereon for releasing multiple document processing operations of claim 16 further comprising instructions for receiving a selection signal representative of a selection of all document processing operations associated with the user.

18. The computer-readable medium of instructions with computer-readable instructions stored thereon for releasing multiple document processing operations of claim 17, wherein the display is generated inclusive of data representative of a plurality of document processing operations upon receipt of valid password input data.

19. The computer-readable medium of instructions with computer-readable instructions stored thereon for releasing multiple document processing operations of claim 18 further comprising:
instructions for selecting at least one of the plurality of document processing operations; and
instructions for deleting the at least one selected document processing operation.

20. The computer-readable medium of instructions with computer-readable instructions stored thereon for releasing multiple document processing operations of claim 17 further comprising:
instructions for receiving administrator login data, inclusive of data representative of an identification of a pre-designated system administrator; and
instructions for displaying, upon receipt of acceptable administrator login data, data representative of a plurality of document processing operations associated with a plurality of users.

21. The computer-readable medium of instructions with computer-readable instructions stored thereon for releasing multiple document processing operations of claim 20, further comprising:
instructions for selecting at least one of the plurality of document processing operations; and
instructions for deleting the at least one selected document processing operation.
